(19) United States
(12) Patent Application Publication
(10) Pub. No.: US 2003/0005410 A1
(43) Pub. Date: Jan. 2, 2003

(54) XML PARSER FOR COBOL

(75) Inventor: GARY L. HARLESS, ANNANDALE, VA (US)

Correspondence Address: STAAS & HALSEY LLP, 700 11TH STREET, NW, SUITE 500, WASHINGTON, DC, 20001, US

(73) Assignee: American Management Systems, Inc. of Fairfax, VA.

(21) Appl. No.: 09/323,687

(22) Filed: Jun. 2, 1999

(51) Int. Cl. G06F 9/45

(52) U.S. Cl. 717/114

(57) ABSTRACT

An XML Parser for COBOL that creates a structure, or table, identifying where in a given data stream a specific data element is located and the length of the element. For each data element tag in the XML data stream, the parser creates a row in a table containing the Tag Name, Field Length, and Field Size of the data element. Once the entire XML data stream has been processed, the parser returns the table containing the position and length of all data elements in the XML data stream. Thus, instead of receiving a virtually unintelligible (by COBOL) data stream, the COBOL program is given a table that serves as a table of contents, if you will, of the data elements in the message.

### BACKGROUND OF THE INVENTION

The present invention is directed to an apparatus including software and a method for parsing XML messages into data readable by programs written in the COBOL language.

XML (eXtensible Markup Language) was originally conceived as the “big brother” of HTML (HyperText Markup Language). It is designed to enable the use of SGML (the international standard metalanguage for markup languages, ISO 8879:1986) on the World Wide Web. XML, in effect, extends HTML and can be used to create entirely new languages or grammars. XML itself is not a single markup language: it's a metalanguage allowing the design of personalized markup languages. A regular markup language, such as HTML defines a way to describe information in a certain class of documents. XML allows the creation of customized markup languages for many classes of documents. The following example may prove useful:

Variable definition in HTML:

<p>P200 Laptop

<br>Friendly Computer Shop

<br>$1438

Same variable definition in XML:

<product>

<model>P200Laptop</model>

<dealer>Friendly Computer Shop</dealer>

<price>$1438</price>

</product>

XML is a public project of the XML Working Group of the World Wide Web Consortium (W3C) which approved the XML v1.0 specification on Feb. 10, 1998. The reader is invited to review the XML material (including the specification) published by the W3C on their web site: http://www.w3.org/XML, the disclosure of which, to the extent necessary, is hereby incorporated by reference. The W3C maintains the specification along with other current documentation at their web site. Version 1.0 of the, XML specification is published at: hhttp://www.w3.org:TR/PR-xml-971208. It is anticipated that the specification for XML will develop over time.

A parser is a program that takes a data stream in one format and transforms the data stream into another format. For example, parsers exist that take an XML stream and produce an object list that can be used by a variety of object oriented languages, including JAVA and C⁺⁺. At the present time, the inventors of the present invention are unaware of any such parser for COBOL, a procedural language which requires a static variable definition including the type and size of the variable. XML, on the other hand, uses string lengths that can be variable in length and records which may be defined with optional fields.

XML defines a schema or style sheet that gets applied to a message. Such a schema or style sheet is termed a Document Type Definition (DTD). The phrase document type refers to both the vocabulary and the constraints on vocabulary usage. The following example may prove useful:

DTD section:

<!ELEMENT CUST (NAME,DOB?,SSN)>

<!ELEMENT NAME (FIRST,MIDDLE?,LAST)>

XML Message using the foregoing DTD:

<CUST><NAME><FIRST>John</FIRST><MIDDLE>R

</MIDDLE><LAST>Doe</LAST></NAME><DOB>032665

</DOB><SSN>123456789</SSN></CUST>

As stated above, parsers are known for a variety of object oriented languages, e.g., JAVA, C++, etc. Parsing XML for such object oriented languages is relatively easy as the data structure, i.e., grammar, in XML is well suited for the object oriented paradigm. Using the sample XML message, such a parser may produce the following Object Tree:

<CUST>

<NAME>

<FIRST>John
<MIDDLE>R
<LAST>Doe

<DOB>032665
<SSN>123456789

Using this object tree, Object Oriented languages can access the customers first name by referring to CUST.NAME.FIRST to obtain “John.”

Procedural languages such as COBOL are not easily able to understand object trees. In general, COBOL needs messages that are defined as static structures of data elements with each data element having a fixed data type and size. To process the sample XML message and extract the customers first name and middle initial, the XML message must be transformed into a typed data structure, such as the following:

CUSTOMER-TAG ALPHA6

NAME-TAG ALPHA6

FIRST-NAME-TAG ALPHA7

FIRST-NAME ALPHA4

FIRST-NAME-END ALPHA8

MID-NAME-TAG ALPHA8

MID-NAME ALPHA1

MID-NAME-END ALPHA9

Such a data structure would be valid for only a specific message as data structures in XML employ variable length string fields and some fields may be defined as optional (using the “?” character as in the sample DTD section). For this to be useful, the data structure must then be filled in with the data. In other words, the XML data must be referenced into this structure.

The flexibility of XML has makes it difficult to create a usable XML parser for languages which use strict variable declarations. This is especially true for COBOL. The present inventors have discovered a new way to parse messages, in XML and other SGML derivative grammars, into a format usable by COBOL and other procedural languages. This is useful for the numerous legacy systems that exist in COBOL. Such legacy systems perform their assigned functions in an efficient and cost effective manner making replacement thereof an unattractive and expensive option. However, the interfaces for such systems are in need of updating to provide graphical user interfacing and the ability to use modern communication standards including the Internet and soon XML. Thus, the ability to transform XML data into data readable by COBOL based systems would be extremely useful and the output of such a transformation in and of itself would be useful, concrete and tangible based, in part, on the avoidance of having to reprogram the entire legacy system in an object oriented language suited to using raw XML data.

### SUMMARY OF THE INVENTION

An object of the present invention is to provide a parser that parses messages in an SGML derivative language to a format usable by a non-object oriented language that uses strict variable declarations.

Another object of the present invention is to provide an XML parser for COBOL.

A more specific object of the present invention is to provide an XML Parser for COBOL that creates a structure, or table, identifying where in a given data stream a specific data element is located and the length of the element.

Additional objects and advantages of the invention will be set forth in part in the description which follows, and, in part, will be obvious from the description, or may be learned by practice of the invention.

The objects of the present invention are met in a parser for XML messages that produces a data structure identifying individual data elements in an XML message stream by location and length. The parser passes this data structure along with the original XML message to the calling routine. The calling routine uses the data structure as an index to access data in the original XML message stream.

Objects of the present invention are also met in an XML Parser for COBOL that creates a structure, or table, identifying where in a given data stream a specific data element is located and the length of the element. For each data element tag in the XML data stream, the parser creates a row in a table containing the Tag Name, Field Length, and Field Size of the data element. Once the entire XML data stream has been processed, the parser returns the table containing the position and length of all data elements in the XML data stream. Thus, instead of receiving a virtually unintelligible (by COBOL) data stream, the COBOL program is given a table that serves as a table of contents, if you will, of the data elements in the message.

The objects and advantages of the present invention, which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of an general purpose computer system suitable for embodying an XML parser in accordance with the present invention.

FIG. 2 is a data flow diagram of an XML parser in accordance with a preferred embodiment of the present invention.

FIG. 3 is a flow chart of a parsing process in the XML parser in accordance with the preferred embodiment of the present invention.

FIG. 4 is a flow chart of an extract tag process in the XML parser in accordance with the preferred embodiment of the present invention.

FIG. 5 is a flow chart of an extract data process in the XML parser in accordance with the preferred embodiment of the present invention.

FIG. 6 is a flow chart of a copybook for use with an XML parser in accordance with the preferred embodiment of the present invention.

### DESCRIPTION OF THE PREFERRED EMBODIMENT

Reference will now be made in detail to the preferred embodiment of the present invention, examples of which are illustrated in the accompanying drawings, wherein like reference numerals refer to like elements throughout.

The detailed description which follows is presented in terms of general processes, procedures and symbolic representations of operations of data bits within a computer memory, associated computer processors, networks, and network devices. The process descriptions and representations used herein are the means used by those skilled in the data processing art to most effectively convey the substance of their work to others skilled in the art. Processes are here, and generally, conceived to be a self-consistent sequence of steps or actions leading to a desired result. Thus, the term “process” is generally used to refer to a series of operations performed by a processor, be it a central processing unit of a computer or a processing unit of a network device, and as such, encompasses such terms of art as “procedures”, “functions”, “subroutines” and “programs.”

In general, the sequence of steps in the process require physical manipulation of physical quantities. Usually, though not necessarily, these quantities take the form of electrical or magnetic signals capable of being stored, transferred, combined, compared or otherwise manipulated. Those of ordinary skill in the art conveniently refer to these signals as “bits”, “values”, “elements”, “symbols”, “characters”, “terms”, “numbers”, or the like. It should be recognized that these and similar terms are to be associated with the appropriate physical quantities and are merely convenient labels applied to these quantities. In general, the present invention relates to method steps, software, and associated hardware configured to process electrical or other physical signals to generate other desired physical signals.

The apparatus set forth in the present application may be specifically constructed for the required purposes or it may comprise a general purpose computer or other network device selectively activated or reconfigured by a computer program stored in the computer. The processes presented herein are not inherently related to any particular computer or other apparatus. In particular, various general purpose machines may be used with programs in accordance with the teachings herein, or it may prove more convenient to construct more specialized apparatus to perform the required method steps. While the present invention can certainly be realized on a so-called personal computer, including those employing the INTEL PENTIUM® architecture, any data processing device capable of performing the required operation may be used, including computers ranging from hand-held devices to main-frames. In the context of COBOL programs, it will be recognized that most COBOL code resides on mid-size to main-frame computers. When used herein, means-plus-function language, in accordance with 35 U.S.C. §112(6), typically encompasses a central processing unit (CPU) with associated software causing it to perform the described functions in conjunction with the CPU's associated hardware.

With respect to the software described herein, one of ordinary skill in the art will recognize that there exists a variety of platforms and languages for creating software for performing the processes outlined herein. One of ordinary skill in the art also recognizes that the choice of the exact platform and language is often dictated by the specifics of the actual system constructed, such that what may work for one type of general purpose computer may not be efficient on another type of general purpose computer. In practice, the present invention can be realized utilizing COBOL. Of course, this is only one example and other development platforms can be used depending upon the exact implementation of the present invention.

One of ordinary skill in the art to which this invention belongs will have an understanding of XML and the ability to program in COBOL. It being recognized that such practitioners do not require specific details of the software, but rather find process descriptions more desirable (due to the variety of suitable hardware and software platforms), such specifics are not discussed to avoid obscuring the invention.

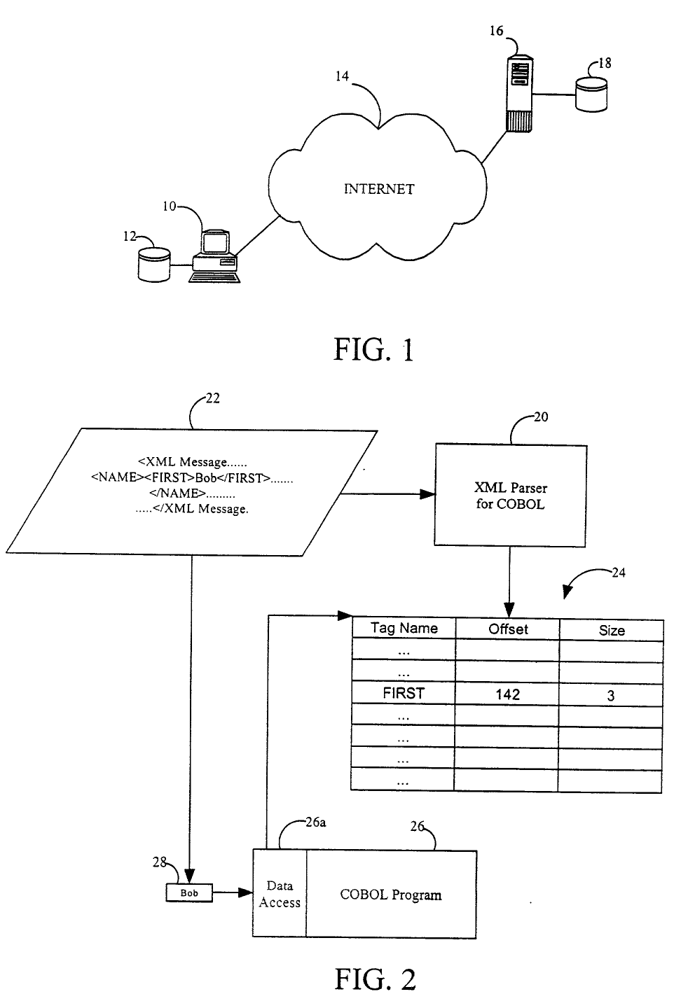

FIG. 1 is a block diagram of a general purpose computer system suitable for embodying an XML parser in accordance with the present invention. A general purpose computer 10, such a personal computer utilizing an INTEL x86 compatible chipset, operates in accordance with software and firmware stored on a computer readable medium 12 (shown separate from the computer 10 for convenience only). The computer readable medium 12 may comprise, for example, a floppy disk, a hard disk, an optical disk (such as a CD-ROM, DVD, or MO), RAM, VRAM, DRAM, SRAM, ROM, EPROM, EEPROM, or a variety of networks and devices from which the computer 10 can retrieve data. Such a network is shown by way of example as being the Internet 14. It is well known that the Internet is really a collection of interconnected network devices, such as a server 16 (which may also be a personal computer utilizing an INTEL x86 compatible chipset or any number of well-known special purpose devices) with associated computer readable medium 18. The server 16 provides data to and receives data from the computer 10 via the Internet 14.

An XML parser in accordance with the present invention could be embodied in either the computer 10 or the server 16. Typically, COBOL programs are used in conjunction with larger systems which may form the server 16 or be connected thereto such that the actual location of the XML parser is a matter left up to the actual programmer.

FIG. 2 is a data flow diagram of an XML parser in accordance with a preferred embodiment of the present invention. An XML parser for COBOL 20 (simply just XML parser 20) receives an XML message 22 for processing. Using a method described herein after, the XML parser 20 analyzes the XML message 22 and produces a data element table 24 referencing the data elements in the XML message 22 by tag name, offset and size. The data element table 24 is constructed in a format readable by a COBOL program 26. The COBOL program 26 may be any process or routine requiring access to XML messages. The COBOL program 26 may be the program which activates or calls the XML parser 20, using a data access process 26a, or such activities may actually be handled by some intermediate routine or even automatically activated upon receipt of an XML message. The COBOL program 26 uses the data element table 24 to retrieve a data element 28 from the original XML message 22.

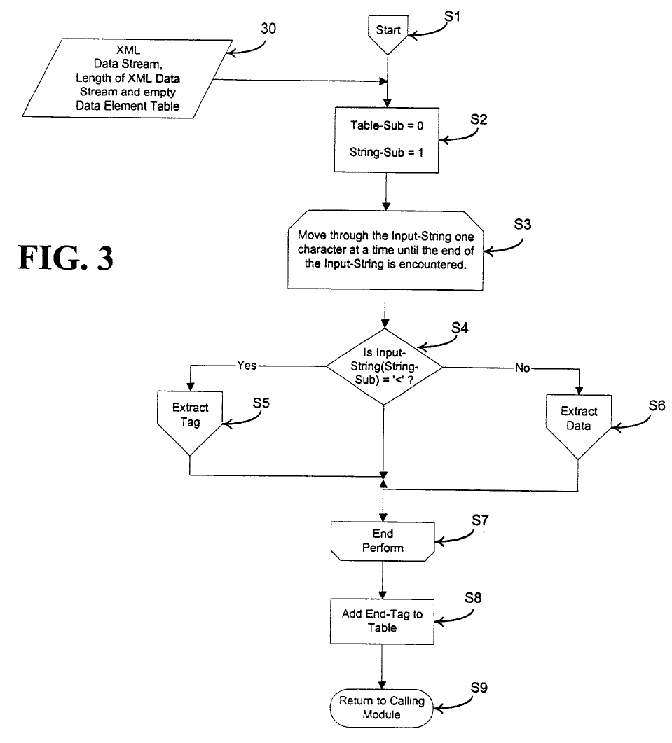

FIG. 3 is a flow chart of a parsing process in the XML parser in accordance with a preferred embodiment of the present invention. The process starts in step S1. The XML Parser 20 receives an input 30 comprising three elements: a length of the XML message, the XML message itself, and an empty data element table. The parsing of the XML message is driven by the length of the message itself. Next in step S2, a Table-Sub variable is set to “0” while a String-Sub variable is set to “1.” The String-Sub variable holds the amount of characters the process has processed and the Table-Sub variable indicates the number of tags processed.

Thereafter in steps S3 through S7, the process examines each character in the message until the length of the message is reached. As part of this loop, each character is first checked for the XML begin tag token, the “<” sign in step S4. When the begin tag token is encountered, specific logic is performed to extract the XML tag in step S5. If the character in the message is not the begin tag token, the character is the beginning of an actual data value and logic is performed, in step S6, to update the data element table with the Offset and Size of the data value. Once the tag or data is extracted, the process performs a return, in step S7, to step S4.

Once all items are extracted the End-Tag is added to the data element table 24 in step S8 and a return to the calling module is made in step S9.

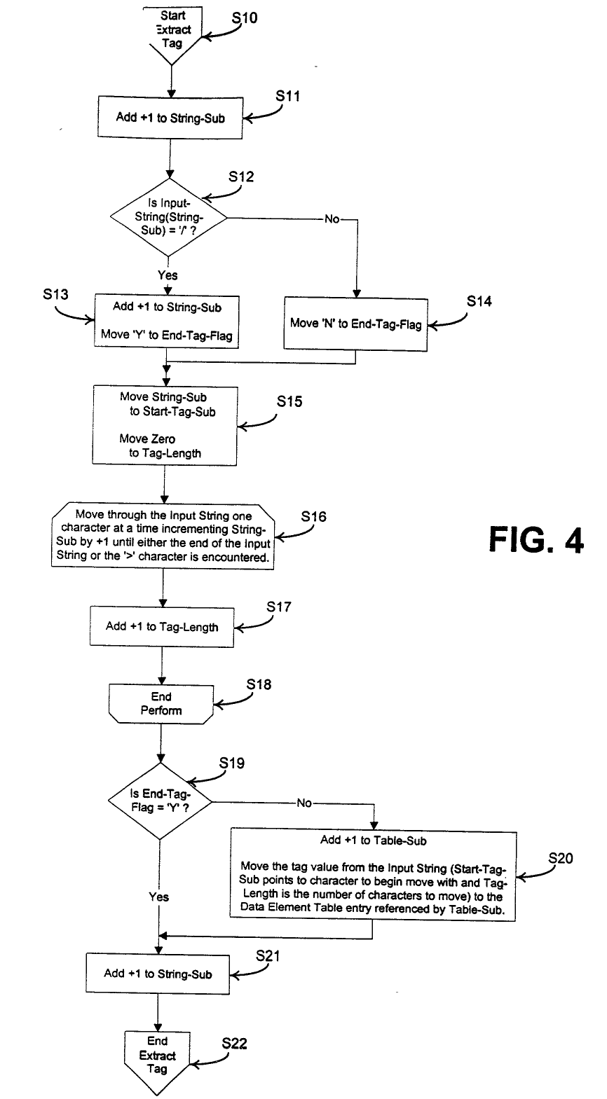

FIG. 4 is a flow chart of an extract tag process S5 in the XML parser in accordance with a preferred embodiment of the present invention. The extract tag process starts in step S10 when called in step S5 shown in FIG. 3. Thereafter, in step S11, “1” is added to the String-Sub variable.

In step S12, the first character after the begin tag token is examined to determine if it is a “/”. The “/” character indicates that the tag is actually marking the end of a data value, referred to as an end-tag hereafter. For example, in the XML message “<FIRST>Bob</FIRST>”, <FIRST> is the begin-tag and </FIRST> is the end-tag. The XML parser extracts and excludes end-tags from the table because they have no significance to the way that COBOL programs process the XML message. If the tag is not an end-tag, the tag value is stored in the data element table.

If the first character is a “/” the process goes to step S13 and an “Y” is moved to an End-Tag-Flag. On the other hand if the first character is not a “/”, the process goes to step S14 and an “N” is moved to an End-Tag-Flag. In either event, the process goes to step S15 and the value of the variable String-Sub is moved to a variable Start-Tag-Sub (as a pointer to the start of the tag) and a “0” is moved to a Tag-length variable. The Tag-Length variable indicates the length of the tag being extracted.

Thereafter, in steps S16 through S18 the input string is extracted by moving through the string and extracting characters until the “>” character is encountered. For each character extracted the String-Sub variable is increased by “1” and a Tag-Length variable is increased by “1”.

Once the tag has been extracted in steps S16 through S18, the process goes to step S19 and the End-Tag-Flag is checked. If the End-Tag-Flag is set to “Y,” the process goes to step S21, a “1” is added to the String-Sub variable and the process ends in step S22. If the End-Tag-Flag is set to “N,” the process goes to step S20 and the tag is extracted. Specifically, a “1” is added to the Table-Sub variable and the string, starting at the character pointed to by the Start-Tag-Sub variable with a length indicated by the Tag-Length variable, the tag is moved to the location indicated by the Table-Sub variable. Thereafter, the process goes to step S21, a “1” is added to the String-Sub variable and the process ends in step S22.

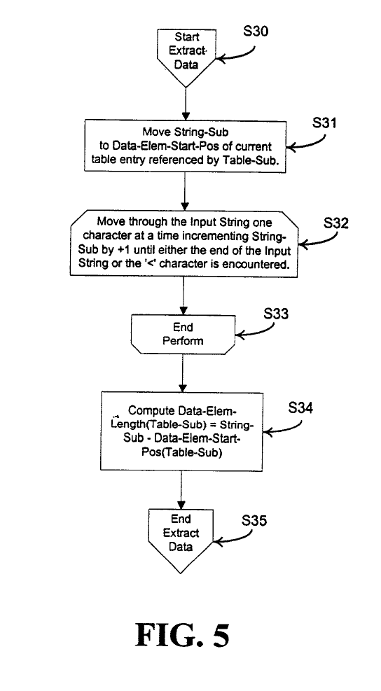

FIG. 5 is a flow chart of an extract data process S6 in the XML parser in accordance with a preferred embodiment of the present invention. The extract data process starts in step S30 when called in step S6 shown in FIG. 3. In step S31 the current position (indicated by the String-Sub variable) in the XML message is stored in the current data element table entry as the Offset. More specifically, the table entry indicated by the Table-Sub variable is updated to reflect the offset of the element.

Next, in steps S32 through S33, the characters in the message are examined until the begin tag token “<” is encountered, indicating the end of the current data value. For each character examined the String-Sub variable is incremented by “1.” Then in step S34 the length of the data value (Data-Elem-Length) is calculated and stored in the current data element table entry as the Size. The process ends in step S35.

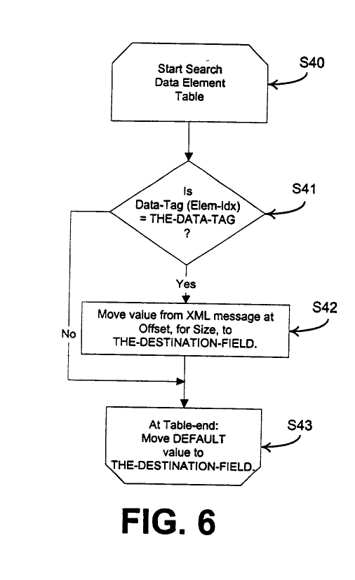

FIG. 6 is a flow chart of a copybook routine for use with an XML parser in accordance with a preferred embodiment of the present invention. Referring to FIG. 2 it is noted that the COBOL Program 26 has a data access portion 26a. The Data Access portion 26a of the COBOL Program 26 can be formed using a generic COBOL copybook as described in FIG. 6. The code to use the copybook routine is:

COPY ZRCXML01 REPLACING

| | |
|---|---|
| THE-DATA-TAG | BY FIRST-NAME-TAG |
| THE-DESTINATION-FIELD | BY CUSTOMER-FIRST-NAME |

In the example shown in FIG. 2, a FIRST-NAME-TAG has a value of “FIRST”. The copybook routine searches the data element table produced by the XML Parser using the FIRST-NAME-TAG as the key. When the search key is found, a COBOL MOVE statement is performed using the Offset and Size related to the Tag Name to place the data element value into a field specified by the COBOL Program 26. In this example, the COBOL Program field is CUSTOMER-FIRST-NAME and the result of executing the code contained in the copybook is that CUSTOMER-FIRST-NAME is equal to “Bob”.

Referring to FIG. 6, the copybook routine starts in Step S40 with the initiation of a search of the data element table 24. For each element, a check is made in step S41 to determine if the element is the element being sought. If the correct element is found, the process goes to step S42 and the content is moved to the destination field specified when calling the copybook and the process ends. If the element is not in the data element table 24 a default element is moved to the destination field in step S43 and the process ends.

The many features and advantages of the invention are apparent from the detailed specification and, thus, it is intended by the appended claims to cover all such features and advantages of the invention which fall within the true spirit and scope of the invention. For example, the present invention is not in any way limited to the initial version of XML, but is adaptable for use with all future versions. The present invention has been described with respect to a parser that is operative on well formed XML data streams, those of ordinary skill in the art will recognize that various methods exist for dealing with non-well formatted data streams containing errors. Error handling routines are, generally, within the ability of one of ordinary skill in the art to construct and are beyond the focus of the present invention, accordingly such details are omitted. The present invention is directed toward parsing the data in an XML message, one of ordinary skill in the art will recognize that similar apparatus and methods may be employed to parse the DTDs. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An XML parser for COBOL comprising:
computer processor means for processing data;
first means for receiving XML data; and
second means for analyzing the XML data and producing a data element table indexing the location of tags in the XML data.

2. An XML parser for COBOL, as set forth in claim 1, wherein said second means produces a table having a first field referencing a tag names; a second field referencing an offset of the data referenced by the tag; and a third field referencing a size of the data referenced by the tag.

3. An XML parser for COBOL, as set forth in claim 1, wherein said second means produces a table in a format native to COBOL.

4. A method of parsing XML data comprising:
receiving XML data;
analyzing the XML data identifying tags and associated data; and
producing a data element table indexing the location of tags in the XML data.

5. The method of claim 4, wherein the step of producing a data element table comprises:
forming a table, readableby a COBOL program, having a first field referencing a tag name; a second field referencing an offset of the data referenced by the tag; and a third field referencing a size of the data referenced by the tag.

6. A computer readable medium encoded with software for use with a COBOL program to permit the COBOL programs to access data in XML, the software causing a computer to perform the actions of:
receiving XML data;
analyzing the XML data identifying tags and associated data;
producing a data element table indexing the location of tags in the XML data; and
interfacing with the COBOL program and when a data element of the XML data is requested accessing the data element table to determine a location of the requested data element, retrieving the requested data element from the determined location and moving the requested data element into a location specified by the COBOL program.

7. A computer readable medium encoded with a data structure comprising:
a table, readable by a COBOL program, having:
a first field referencing tag names in an XML message;
a second field referencing an offset of the data referenced by the tag; and
a third field referencing a size of the data referenced by the tag;
whereby a COBOL program can access the data in the XML message.

8. A parser for a programming language requiring static definition of variables, the parser comprising:
computer processor means for processing data;
first means for receiving data with data elements formed in a mark-up language; and
second means for analyzing the data and producing a data element table in a format usable by the programming language indexing the location of data elements in the data.

9. A parser as set forth in claim 8, wherein said second means produces a table, directly readable by the programming language, having a first field identifying the data elements; a second field referencing an offset of the data elements; and a third field referencing a size of the data elements.

10. A method of parsing XML comprising:
receiving an XML data stream, a length of the XML data stream, and an empty data element table; and
analyzing the XML data stream one character at a time by performing the following actions:
when a begin tag character is encountered, extracting the next series of characters as a tag and updating a data element table to reflect any begin tags; and
when an end tag character is encountered, extracting the next series of characters as a data element and updating a data element table to point to the data as indexed by an associated tag.

11. A method, as set forth in claim 10, wherein the begin tag character is a “<” and the end tag character is a “>” and step of extracting the next series of character as a tag comprises:
determining if the character after the “<” is a “/”, indicating that the tag is an end tag;
if the tag is not an end tag, extracting the subsequent characters until the end of the string or a “>” is encountered; and
moving the extracted tag into the data element table.

12. A method, as set forth in claim 10, wherein the step of extracting the next series of character as a data element comprises:
moving the offset of the data element into the data element table in association with the related tag;
extracting the characters of the data element until the end of the string or a begin tag character is encountered;
calculating the length of the data element; and
moving the length of the data element into the data element table in association with the related tag.

14. A computer readable medium encoded with a data structure comprising:
a table, readable by a programming language requiring static definition of variables, having:
a first field referencing tag names in an XML message;
a second field referencing an offset of the data referenced by the tag; and
a third field referencing a size of the data referenced by the tag;
whereby the programming language can access the data in the XML message.
